(19) United States
(12) Patent Application Publication
(10) Pub. No.: US 2007/0236933 A1
(43) Pub. Date: Oct. 11, 2007

(54) Angular dependent element positioned for color tuning

(75) Inventors: Serge J. Bierhuizen, Milpitas, CA (US); Gerard Harbers, Sunnyvale, CA (US); Matthijs H. Kueper, San Jose, CA (US)

Correspondence Address: PATENT LAW GROUP LLP, 2635 NORTH FIRST STREET, SUITE 223, SAN JOSE, CA, 95134, US

(73) Assignee: Philips Lumileds Lighting Company LLC, San Jose, CA (US)

(21) Appl. No.: 11/400,448

(22) Filed: Apr. 6, 2006

(51) Int. Cl. F21V 9/00

(52) U.S. Cl. 362/293

(57) ABSTRACT

A light emitting device includes a light source that produces light having a range of wavelengths and an angular dependent element that filters the light. The angular dependent element, may be, e.g., a dichroic filter, dichroic mirror, a cholesteric film, a diffractive filter, and a holographic filter. The angular dependent element having one or more ranges in which wavelengths of light are more efficiently propagated than wavelengths of light that are not within the one or more ranges. The angular dependent element is positioned at an angle with respect to the optical axis. By adjusting the angular position of the angular dependent filter with respect to the optical axis, the wavelengths of light produced by the light emitting device can be controlled to select a desired color of light.

### FIELD OF THE INVENTION

The present invention relates generally to light emitting devices and in particular to controlling the color of light produced by light emitting devices and phosphors.

### BACKGROUND

Lighting devices that use light emitting diodes (LEDs) are becoming increasingly common in many lighting applications. Generally, LEDs use phosphor conversion of the primary emission to generate white light, but phosphors can also be used to create more saturated colors like red, green and yellow. Unfortunately, the light produced by phosphor converted LEDs tends to have an amount of color variation. Variations in the color of light produced by PC (Phosphor Converted) LEDs are due to, e.g., variations in the LED spectral emission, variations in the phosphor thickness and production variations of a dichroic filter that can be used in for example LED based projection systems. With such variations it is difficult to precisely control the color of the light of such LED devices.

Many lighting applications, however, require such a high degree of color control. For example, lighting applications in studios, theaters and shops along with displays require very precise color control, as even small changes in the color of the light will be noticed. Accordingly, what is needed is an improved lighting system that can generate a high degree of control for the color of the light.

### SUMMARY

In accordance with an embodiment of the present invention, a light emitting device includes a light source that produces light having a plurality of wavelengths and an angular dependent element that filters the light. The angular dependent element has one or more ranges in which wavelengths of light are more efficiently propagated than wavelengths of light that are not within the one or more ranges. The angular dependent element is positioned at an angle with respect to the optical axis. By adjusting the angular position of the angular dependent filter with respect to the optical axis, the wavelengths of light produced by the light emitting device can be controlled to select a desired color of light.

### BRIEF DESCRIPTION OF THE DRAWINGS

FIG. 1 illustrates a color tunable lighting device that includes a light source and an angular dependent filter held at an angular position with respect to the optical axis.

FIG. 2 illustrates another embodiment of a color tunable light device.

FIG. 3 is a graph illustrating the angular dependence of a dichroic filter as a function of wavelength and transmission.

FIG. 4 is a graph, illustrating the angular dependence of a band pass dichroic filter as a function of wavelength and transmission.

FIG. 5 is a graph illustrating the spectrum produced by a device using a blue LED and a YAG phosphor, and the spectrum transmitted by a dichroic notch filter.

FIG. 6 illustrates another embodiment of a color tunable lighting device that includes two angular dependent filters held at angular positions with respect to the optical axis.

### DETAILED DESCRIPTION

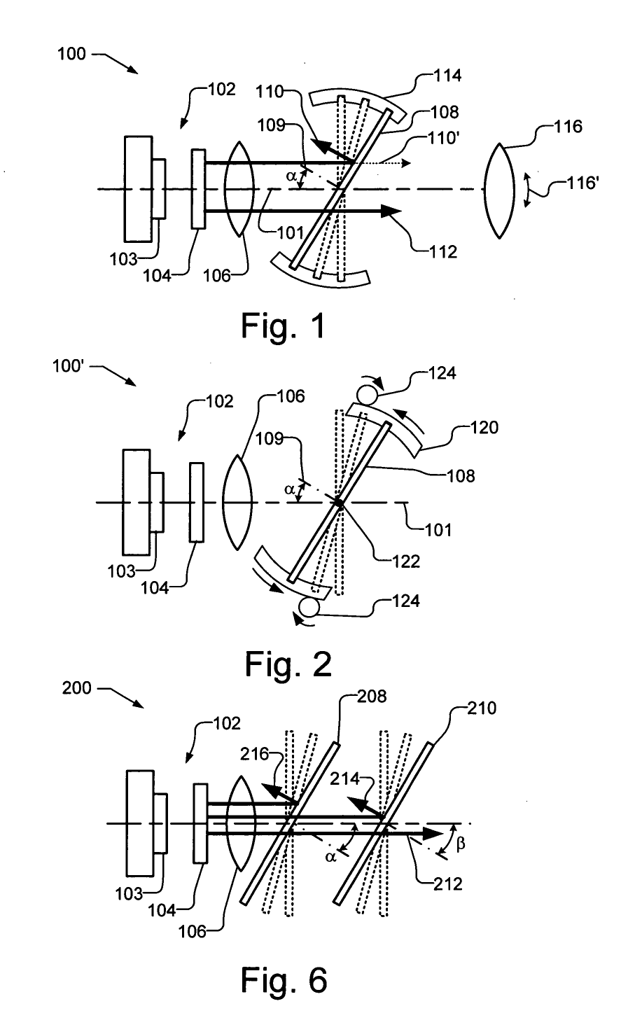

FIG. 1 illustrates a color tunable lighting device 100 that includes a light source 102, such as a blue or UV light emitting diode (LED) 103 and a wavelength converting layer 104, and a collimating optic 106, such as a collimating lens or a compound parabolic concentrator (CPC) or similar structure. In some embodiments, the light source 102 may be a broadband light source instead of an LED 103, in which case, the wavelength converting layer 104 may not be needed.

In the embodiment in which the wavelength converting layer 104 is used, the wavelength converting layer 104 may be attached to the LED 103 or, alternatively, may be remote, i.e., unattached to the light source 103. The wavelength converting element 104 may be a phosphor coating, such as YAG or other appropriate material. The combination of the light converted by the wavelength converted element 104 and the light emitted by the LED 103 that leaks through the wavelength converting element 104 determines the specific wavelengths of the light produced.

The collimating optic 106 receives the light produced by the light source 102 and approximately collimates the light along the optical axis 101. In one embodiment, the collimating optic 106 collimates the light to less than a half cone angle of 60°.

As illustrated in FIG. 1, the lighting device 100 also includes an angular dependent filter 108 that is held at an angular position with respect to the optical axis 101, i.e., the surface normal of the angular dependent filter 108, illustrated by line 109, is at a non-parallel angle α with respect to the optical axis 101. The angular dependent filter 108 may be, e.g., a dichroic filter, a cholesteric film, a diffractive or holographic filter or any other angularly dependent element in which the spectrum changes as a function of angle of incidence. Moreover, the angular dependent filter 108 may operate by way of transmission or reflection, for example, a dichroic mirror may b used, as opposed to a dichroic filter. For ease of reference, the angular dependent filter 108 may sometimes be referred to herein as an angular dependent element, dichroic filter, or dichroic element. As shown in FIG. 1, the angular dependent filter 108 can be positioned at different angles a, as illustrated by the broken lines, which alters the color of light produced by the lighting device 100. By way of example, the angular position α of the angular dependent filter 108 may be varied from and including 0° to 60° to produce the desired color of light.

Through careful selection or adjustment of the angle α, the colors produced by the light source 102 may be improved. Thus, the color of light generated by light sources such as phosphor converted LEDs or plasma lamps may be controlled. Further, the light produced by sources such as Mercury lamps, with unwanted wavelength spikes may be similarly improved.

In one embodiment, the angular dependent filter 108 may be fixedly mounted in a frame at a single angular position α. In another embodiment, the angular position α of the angular dependent filter 108 may be adjustable. By way of example, a frame 114 may be capable of holding the angular dependent filter 108 at various angular positions. In one embodiment, the frame 114 may include a plurality of locations or notches to hold the angular dependent filter 108 at various angular positions. While FIG. 1 illustrates only 3 locations to hold the angular dependent filter 108, it should be understood that many more locations may be included within the frame 114. The angular position of the angular dependent filter 108 may be adjusted by removing the angular dependent filter 108 from one location and moving the angular dependent filter 108 to another location.

In another embodiment, the angular position of the angular dependent filter 108 maybe adjusted by rotating the angular dependent filter 108. FIG. 2, by way of example, illustrates a light emitting device 100′, which is similar to that shown in FIG. 1, like designated elements being the same. The light emitting device 100′, however, includes a frame 120 that holds the angular dependent filter 108 and that is rotated about an axis 122 that is perpendicular to the optical axis 101. The frame 120 may be rotated, e.g., using rollers 124, as indicated by the arrows. The rotation of angular dependent filter 108 may be controlled, e.g., by a motor or manually. Of course, the angular position of the angular dependent filter 108 may be varied in other ways. For example, the angular dependent filter 108 may be rotatably held at one end and the other end pivoted, e.g., using a screw or a spacer.

The optical axis 101 may shift due to the adjustment of the angular position of the angular dependent filter 108. Accordingly, downstream optical components 116 may be adjusted as illustrated by arrow 116′ in FIG. 1 in order to compensate for the shift in the optical axis 101. Alternatively, the system can be designed to be insensitive to the change in the optical axis, e.g., by designing the system with a wider illumination bundle, i.e., overscan the system.

The use of an angular dependent filter 108 that can be selectively mounted at an angle α with respect to the optical axis 101 provides an improved yield of the color for lighting devices, particularly for devices that use light emitting diodes. Moreover, the yield is improved and cost reduced for systems that use angular dependent filters, such as dichroic filters, to manipulate or combine light, i.e., the performance parameters of the angular dependent filter need not be so tightly controlled. Moreover, in an embodiment in which the customer is permitted to vary the angle α of the angular dependent filter, the customer can select and vary the color produced by the lighting device without requiring a redesign of the lighting system 100.

The angular dependent filter 108 propagates along the optical axis 101 a desired subset of wavelengths (illustrated by line 112 in FIG. 1) out of the full range of wavelengths produced by light source 102 and incident on the angular dependent filter 108. Any wavelengths outside the subset of wavelengths propagated by angular dependent filter 108 may be completely or partially reflected as illustrated by line 110. In one embodiment, the reflected light may be recycled, e.g., using a CPC, which will direct the reflected light back to the wavelength converting layer 104 where the light can be used again for wavelength conversion, such as that described in U.S. Pub. 2005/0270775, which is incorporated herein by reference. Alternatively, with the use of a nominal angle α that is non-parallel with the optical axis 101 (and no CPC), the reflected light may be permanently removed from the optical path. For example, in the case of blue pump recycling, a non-parallel angle α can be used to control the amount of blue to phosphor recycling.

In some embodiments, the angular dependent filter 108 may transmit along the optical axis 101 additional wavelengths, i.e., wavelengths outside the desired subset of wavelengths 112. The additional wavelengths, illustrated by line 110′ in FIG. 1, may include leakage or may be approximately all or most of the full range of wavelengths produced by the light source 102. The angular dependent filter 108, however, propagates the desired subset of wavelengths 112 with greater efficiency than the wavelengths 110′ outside the subset of wavelengths.

A suitable angular dependent filter that may be used with an embodiment of the present invention is a dichroic filter manufactured by JDSU, Bookham, or Unaxis. One manufacturing method for a suitable dichroic filter is described in, e.g., U.S. Pat. No. 5,292,415. Of course, other manufacturing methods may be used if desired. An example of commercially available Red, Green, and Blue additive filters are NT52-546 from Edmund Optics. Any angular dependent element may be used with the present invention as long as the light propagated by the angular dependent element has an angular dependence, i.e., the spectrum along the primary propagation direction, i.e., along the optical axis, whether that is by transmission, reflection, or diffraction, changes as a function of angle of incidence.

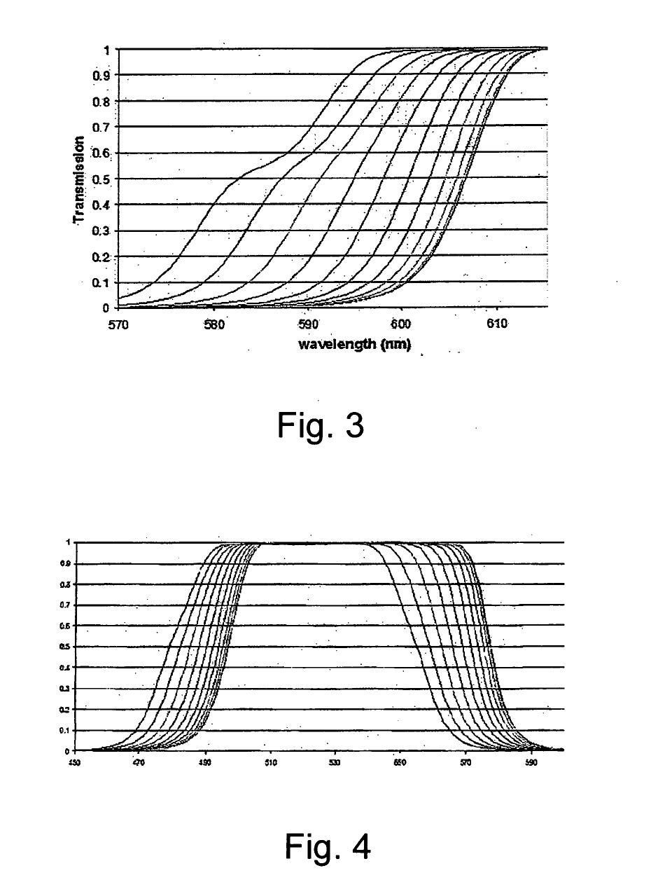

FIG. 3 is a graph illustrating the angular dependence of one suitable dichroic filter as a function of wavelength and transmission, where each curve illustrates a different angle of incidence, from 0° (normal incidence) to 30° in 3° increments, where normal incidence is represented by the curve to the right and 30° is represented by the curve to the left. As can be seen, the transmission spectrum varies as a function of the angle of incidence. For example, at 50% transmission, the wavelength changes from approximately 605 nm for light that is incident at 0° to approximately 582 nm for light that is incident at 30°.

By altering the angular position α of the angular dependent filter 108 with respect to the optical axis 101, the shift in the transmission spectrum of the angular dependent filter 108 is used to control the color of the light produced by the lighting device 100. The alteration of the angular position angular dependent filter 108 may be made after first determining the color of the light produced by the light device 100. After a determination of the color of the light is made, the angular position of the angular dependent filter 108 may be appropriately adjusted to produce the desired color of light. In one embodiment, the adjustment of the angular position α of the angular dependent filter 108 is a factory calibration, in which the angular dependent filter 108 is mounted at the necessary angular position α to produce the desired color.

Alternatively, the customer or end user can adjust the angular position α of the angular dependent filter 108 to produce the color of light desired by the customer or end user. In such an embodiment, the angular position of the angular dependent filter 108 may be adjusted by rotating the angular dependent filter 108, e.g., using a motorized system or manually, as illustrated in FIG. 2. The user can then select between a high flux mode with a small color gamut or a high color gamut but with decreased brightness by varying the angular position α of the angular dependent filter 108. Filters with a higher angular dependency can be designed specifically for this purpose. For example, a dichroic coating is formed using a stack of multiple layers of higher and lower refractive materials. Typically, a filter is desired with low angular dependency by appropriately choosing different coating materials with higher refractive indices and optimized thicknesses. Through the appropriate choice of deposition materials and layer thickness, however, the opposite effect, i.e., high angular dependence, can be created.

In one embodiment, the angular dependent filter 108 may be a band pass filter. FIG. 4 is a graph, similar to that shown in FIG. 3, illustrating the angular dependence of a band pass dichroic filter as a function of wavelength and transmission. As illustrated in FIG. 4, the band pass filter transmits green light and reflects the blue (pump) light. The red component of the light is also filtered out to obtain better color saturation. By adjusting the angular position α of the band pass filter the desired color can be produced even if the wavelength converting element 104 produces the wrong color. Thus, efficient and stable wavelength converting elements, such as YAG phosphor, can be used even if they produce the wrong color.

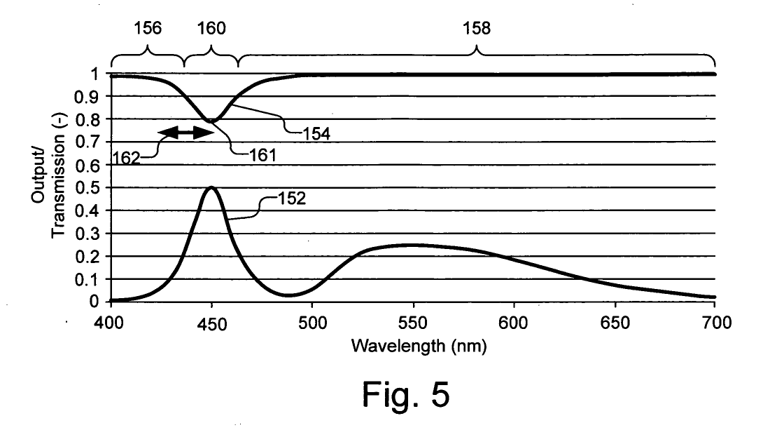

FIG. 5 is a graph illustrating the operation of a color tunable lighting device, such as device 100, in accordance with an embodiment of the present invention. The lower curve 152 illustrates the spectrum produced by the device 100, which may use a light source 102 that is a blue LED 103 with a YAG phosphor wavelength converting element 104. While the light source 102 is considered to produce white light, as can be seen in curve 152, the spectrum of the white light includes a peak at the blue pump wavelength and a yellow (green+red) emission from the YAG phosphor, which partly absorbs and partly transmits the blue pump light. In many cases, the exact ratio between the blue and yellow wavelengths is not perfectly controlled, causing the white point to be off-target (e.g. the black body curve).

FIG. 5 also illustrates as upper curve 154 the spectrum transmitted by an angular dependent filter 108. As illustrated in FIG. 5, the angular dependent filter 108 is a notch filter that is designed to transmit most of the light, except for a small portion of the blue light, which may be reflected by the angular dependent filter 108 and returned to the phosphor wavelength converting element 104, where the light may be partly absorbed and remitted as additional yellow light. As illustrated in FIG. 5, the angular dependent filter 108 includes two transmission ranges, range 156 and range 158, and one rejection band 160, which includes wavelengths outside the transmission ranges. Light within the transmission ranges 156, 158 are more efficiently propagated along the optical axis than wavelengths in the rejection band 160. As can be seen, however, even wavelengths within the rejection band 160 may be transmitted by the angular dependent filter 108. If desired, the angular dependent filter 108 may be a short wave pass, long wave pass, band pass, or notch filter. Moreover, if desired, the angular dependent filter 108 may be a combination of two or more types of filters, so that, e.g., there are more than rejection bands and/or more than one transmission ranges.

The angular dependent filter 108 may be held in the device 100 at a nominal angular position of 0° with respect to the optical axis. To change the color point of the light produced by the device 100, the angular position of the angular dependent filter 108 may be varied, which will move the blue reflection peak 161, i.e., the peak of the rejection band 160, to lower wavelengths, as indicated by arrow 162. Thus, the angular position of the angular dependent filter 108 is selected to place a desired range of wavelengths within the two transmission ranges 156, 158. Consequently, the angular dependent filter 108 will transmit more of the blue light resulting in a more bluish white light being produced by device 100. Thus, by appropriate selection of the angular position of the angular dependent filter 108, light having a desired color can be propagated along the optical axis 101 by the angular dependent filter 108.

FIG. 6 illustrates a color tunable lighting device 200 that includes a light source 102 including a wavelength converting layer 104, a collimating optic 106, and two angular dependent filters 208 and 210 held at angular positions α and β, respectively. By way of example, the first angular dependent filter 208 transmits green and red light, illustrated by arrows 212 and 214, while reflecting blue light, illustrated by arrow 216. The second angular dependent filter 210 transmits green light 212 and reflects red light 214. In one embodiment, the angular positions α and β of angular dependent filters 208 and 210 can be separately adjusted, which permits independent tuning of the blue end and the red end of the spectrum illustrated in FIG. 4.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A light emitting device that emits light having a desired color, the light emitting device comprising:
a light source comprising at least one light emitting diode, the light source producing a spectrum of light having a plurality of wavelengths along an optical axis; and
an angular dependent element that changes the propagated spectrum, the angular dependent element having an angular position on the optical axis such that the surface normal of angular dependent element is non-parallel with the optical axis, the light from the light source is incident on the angular dependent element, the angular dependent element having a range wherein wavelengths of light within the range are more efficiently propagated than wavelengths of light that are not within the range, the wavelengths of light that are within the range are dependent on the angular position of the angular dependent element with respect to the optical axis, the angular position of the angular dependent element with respect to the optical axis is selected to place a desired range of wavelengths of the light from the light source within the range in order to propagate light with a desired color.

2. The light emitting device of claim 1, further comprising a means for adjusting the angular position of the angular dependent element with respect to the optical axis to vary the wavelengths that are within the transmission range of the angular dependent element.

3. The light emitting device of claim 1, wherein the angular dependent element is fixedly mounted at the angular position on the optical axis.

4. The light emitting device of claim 1, wherein the angular dependent element is rotatably mounted on the optical axis.

5. The light emitting device of claim 1, wherein the angular dependent element is one of a dichroic filter, dichroic mirror, a cholesteric film, a diffractive filter, and a holographic filter.

6. The light emitting device of claim 1, wherein the angular dependent element is one of a short wave pass, long wave pass, band pass and notch filter.

7. The light emitting device of claim 1, wherein that light emitting device comprises more than one angular dependent element.

8. The light emitting device of claim 7, wherein the angular dependent element is a first angular dependent element, the light emitting device further comprising:
a second angular dependent element that changes the propagated spectrum, the second angular dependent element having an angular position on the optical axis such that the surface normal of angular dependent element is non-parallel with the optical axis, wherein the light propagated by the first angular dependent element is incident on the second angular dependent element, the second angular dependent element having a range wherein wavelengths of light within the range of the second angular dependent element are more efficiently propagated than wavelengths of light that are not within the range of the second angular dependent element, the wavelengths of light that are within the range of the second angular dependent element are dependent on the angular position of the second angular dependent element with respect to the optical axis, the angular position of the second angular dependent element with respect to the optical axis is selected to place a desired range of wavelengths of the light from the first angular dependent element within the range of the second angular dependent element in order to propagate light along the optical axis with the desired color.

9. The light emitting device of claim 1, further comprising a collimator between the light source and the angular dependent element.

10. The light emitting device of claim 1, wherein approximately no wavelengths that are not within the range of the angular dependent element are propagated.

11. The light emitting device of claim 1, wherein the angular dependent element has more than one range in which wavelengths of light are more efficiently propagated than wavelengths of light that are not within the more than one range.

12. The light emitting device of claim 1, wherein the light source is at least one light emitting diode with a wavelength converting layer that produces the spectrum of light having a plurality of wavelengths.

13. A light emitting device comprising:
a light source that produces a spectrum of light having a plurality of wavelengths along an optical axis;
an angular dependent element that changes the propagated spectrum, the angular dependent element positioned on the optical axis to receive the light having a plurality of wavelengths, the angular dependent element having a surface normal that defines an angular position of the angular dependent element with respect to the optical axis, the angular dependent element having a range wherein wavelengths of light within the range are more efficiently propagated than wavelengths of light that are not within the range, the wavelengths of light that are within the range are dependent on the angular position of the angular dependent element with respect to the optical axis; and
a means for adjusting the angular position of the angular dependent element with respect to the optical axis to select the wavelengths that are in the range.

14. The light emitting device of claim 13, further comprising a frame having multiple locations to hold the angular dependent element, wherein the means comprises removing the angular dependent element from one location on the frame and positioning the angular dependent element at a different location on the frame to place the angular dependent element at a desired angular position.

15. The light emitting device of claim 13, wherein the means for adjusting comprises rotating the angular dependent element to place the angular dependent element at a desired angular position.

16. The light emitting device of claim 13, wherein the angular dependent element is one of a dichroic filter, dichroic mirror, a cholesteric film, a diffractive filter, and a holographic filter.

17. The light emitting device of claim 13, wherein the angular dependent element is one of a short wave pass, long wave pass, band pass and notch filter.

18. The light emitting device of claim 13, wherein the angular dependent element is a first angular dependent element, the light emitting device further comprising:
a second angular dependent element positioned on the optical axis after the first angular dependent element wherein light propagated by the angular dependent element is incident on the second angular dependent element.

19. The light emitting device of claim 13, wherein the light source is at least one light emitting diode with a wavelength converting layer that produces a spectrum of light having a plurality of wavelengths along an optical axis.

20. The light emitting device of claim 13, further comprising a collimator between the light source and the angular dependent element.

21. The light emitting device of claim 13, wherein approximately no wavelengths that are not within the range of the angular dependent element are propagated.

22. The light emitting device of claim 13, wherein the angular dependent element has more than one range in which wavelengths of light are more efficiently propagated along the optical axis than wavelengths of light that are not within the more than one range.

23. A method of producing light having a desired color, the method comprising:
generating light having a plurality of wavelengths;
filtering the light with an angular dependent element that changes the spectrum of the propagated light, the light is incident on the angular dependent element at a first angle of incidence, the angular dependent element having at least one range wherein wavelengths of light within the at least one range are more efficiently propagated than wavelengths of light that are not within the at least one range; and
adjusting the angular position of the angular dependent element so that the light is incident on the angular dependent element at a different angle of incidence to alter the wavelengths that are in the at least one range so that the propagated light has a desired color.

24. The method of claim 23, further comprising determining the color of the light propagated by the filter prior to adjusting the angular position of the angular dependent element.

25. The method of claim 23, wherein generating light having a plurality of wavelengths comprises:
producing light from at least one light emitting diode; and
converting the light from the at least one light emitting diode to generate the light having a plurality of wavelengths.

26. The method of claim 23, wherein adjusting the angular position of the angular dependent element comprises changing the location of where the angular dependent element is held within a frame.

27. The method of claim 23, wherein adjusting the angular position of the angular dependent element comprises rotating the angular dependent element.

28. The method of claim 23, further comprising collimating the light prior to filtering the light.

29. A method of producing light having a desired color, the method comprising:
providing a light source that generates light having spectrum of a plurality of wavelengths, the light source including a light emitting diode;
providing an angular dependent element that changes the propagated spectrum as a function of an angular position of the angular dependent element with respect to the light generated by the light source; and
selecting an angular position of the angular dependent element to produce a desired spectrum, the selected angular position producing a non-normal angle of incidence between the light generated by the light source and the angular dependent element.
